(19) United States
(12) Patent Application Publication
(10) Pub. No.: US 2009/0286556 A1
(43) Pub. Date: Nov. 19, 2009

(54) APPARATUS, METHOD, AND PROGRAM FOR OUTPUTTING PRESENT POSITION

(75) Inventors: Taku YUMOTO, Wako City (JP); Fumio ANEKOJI, Ninomiya (JP)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: FREESCALE SEMICONDUCTOR, INC, Austin, TX (US)

(21) Appl. No.: 12/436,147

(22) Filed: May 6, 2009

(30) Foreign Application Priority Data
May 19, 2008 (JP) 2008-131190
Jun. 19, 2008 (JP) 2008-160565

(51) Int. Cl. H04W 24/00; G01B 13/12; G06F 15/00

(52) U.S. Cl. 455/456.6; 702/166

(57) ABSTRACT

An apparatus, method and program for outputting a present position that enables a user to be located with further accuracy even in a multi-level area. A control unit periodically sends a reference atmospheric pressure information obtaining request to a base station and obtains reference atmospheric pressure information including the atmospheric pressure and altitude of the base station from the base station and stores the obtained information in a data storage. The control unit uses the measurement value of atmospheric pressure obtained from a pressure sensor and an altitude calculation equation including the reference atmospheric pressure information to periodically calculate and record in the data storage the altitude of the present position. When an emergency button is pushed, the control unit issues to an emergency contact an emergency notification including the present altitude or the altitude recorded in the data storage.

### BACKGROUND OF THE INVENTION

The present invention relates to a present position output apparatus, present position output method and present position output program for outputting information on the altitude of a user's present position.

Emergency calls from cell phones are increasing along with the spread of cell phones. Thus, recent cell phones having a GPS function are useful for “emergency call position notification,” which provides the police or fire department with position information based on GPS measurements. A cell phone having no GPS function provides position information obtained from the location of a base station and the radio wave range.

A cell phone having a function for measuring elevation to determine the present altitude is being developed (refer to Japanese Laid-Open Patent Publication No. 2006-145340). In the cell phone described in the publication, the elevation of a position is obtained from position information, which is generated with the GPS, and map information, which is stored in a map information storage means. The cell phone uses the obtained elevation of the position and atmospheric pressure, which is measured by an atmospheric pressure means, to correct a conversion table for converting the atmospheric pressure into elevation. The cell phone uses the corrected conversion table to convert the measured atmospheric pressure into elevation and displays the elevation. Thus, the elevation can be measured accurately irrespective of the weather.

However, the user's present position, which includes information in the elevation-wise direction, cannot be determined only from two-dimensional map information. For example, when the user is inside a tall multi-level building, the GPS function would locate the user inside the building. However, it cannot be determined on which level, or floor of the building the user is located. Therefore, when the user makes an emergency call from inside a tall building, the user cannot be located. In another example, when driving a car with a navigation system along a multi-level road (e.g., such as freeway and its side road), it is difficult to determine on which level of the road the car is traveling using only two-dimensional map information. The aforementioned publication does not suggest the location of a certain position in multi-level structures.

Accordingly, it is an object of the present invention to provide an apparatus, method, and program for outputting a present position that enables a user to be located with further accuracy even in a multi-level area.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing a cell phone serving as a present position output apparatus according to an embodiment of the present invention;

FIG. 2 is a block diagram showing the internal structure of a cell phone in accordance with a first embodiment of the invention;

FIG. 3 is a flowchart illustrating an indoor-outdoor specifying process in accordance with the first embodiment of the invention;

FIG. 4 is a flowchart illustrating an altitude calculation equation updating process in accordance with the first embodiment of the invention;

FIG. 5 is a flowchart illustrating an emergency contact process in accordance with the first embodiment of the invention;

FIG. 6 is a graph illustrating an indoor correction value in accordance with the first embodiment of the invention;

FIG. 7 is a flowchart illustrating a level movement detection pattern in accordance with the first embodiment of the invention;

FIG. 8 is a schematic diagram illustrating a modified example in accordance with the first embodiment of the invention;

FIG. 9 is a block diagram illustrating the internal structure of a navigation apparatus serving as a present position output apparatus in accordance with the present invention; and

FIG. 10 is a flowchart illustrating a processing method for a location specifying process in accordance with a second embodiment of the invention.

### DETAILED DESCRIPTION OF THE PREFERRED EMBODIMENTS

One aspect of the present invention is a present position output apparatus including a pressure sensor that measures atmospheric pressure. An atmospheric pressure data memory stores the atmospheric pressure measured by the pressure sensor. A control means includes a detection means for detecting movement into a multi-level area. A reference atmospheric pressure recording means obtains a reference elevation and a reference atmospheric pressure in correspondence with the multi-level area and recording the reference elevation and reference atmospheric pressure to the atmospheric pressure data memory. An elevation specifying means compares the atmospheric pressure measured by the pressure sensor with the reference atmospheric pressure and specifies the elevation of a present position at which the atmospheric pressure was measured based on the comparison result. An output means outputs information related to the specified elevation of the present position.

Other aspects and advantages of the present invention will become apparent from the following description, taken in conjunction with the accompanying drawings, illustrating by way of example the principles of the invention.

### First Embodiment

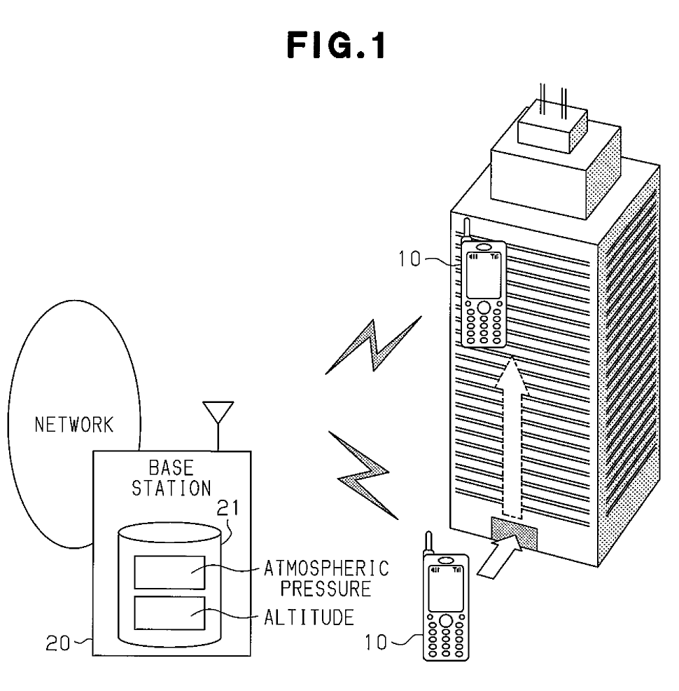

A first embodiment of the present invention will now be discussed with reference to FIGS. 1 to 7. The first embodiment is a present position output apparatus that outputs a user's present position when, for example, an emergency call is made to the fire department or police. In such a case, the present position output apparatus is used to notify information including the altitude of the present position, which is helpful for specifying the level of a building on which the user is located.

Referring to FIG. 1, as known in the art, a cell phone 10, which serves as the present position output apparatus, exchanges data with a base station 20. The base station 20 is connected via a network to the fire department or police in case of emergency.

In the first embodiment, the base station 20 includes an atmospheric pressure measurement apparatus for measuring atmospheric pressure. The base station 20 also includes a reference data memory 21 for storing reference atmospheric pressure information. The reference atmospheric pressure information includes the altitude of the atmospheric pressure measurement apparatus (altitude of the base station 20) and the atmospheric pressure measured at the base station 20. In the present embodiment, the altitude of the base station 20 is used as a reference elevation and the atmospheric pressure measured at the base station 20 is used as a reference atmospheric pressure. The base station 20 periodically obtains the atmospheric pressure measured by the atmospheric pressure measurement apparatus to record and update the atmospheric pressure in the reference data memory 21 as atmospheric pressure of reference atmospheric pressure information. Then, the base station 20 periodically transmits the reference atmospheric pressure information stored in the reference data memory 21 to the cell phone 10 in response to requests from the cell phone 10.

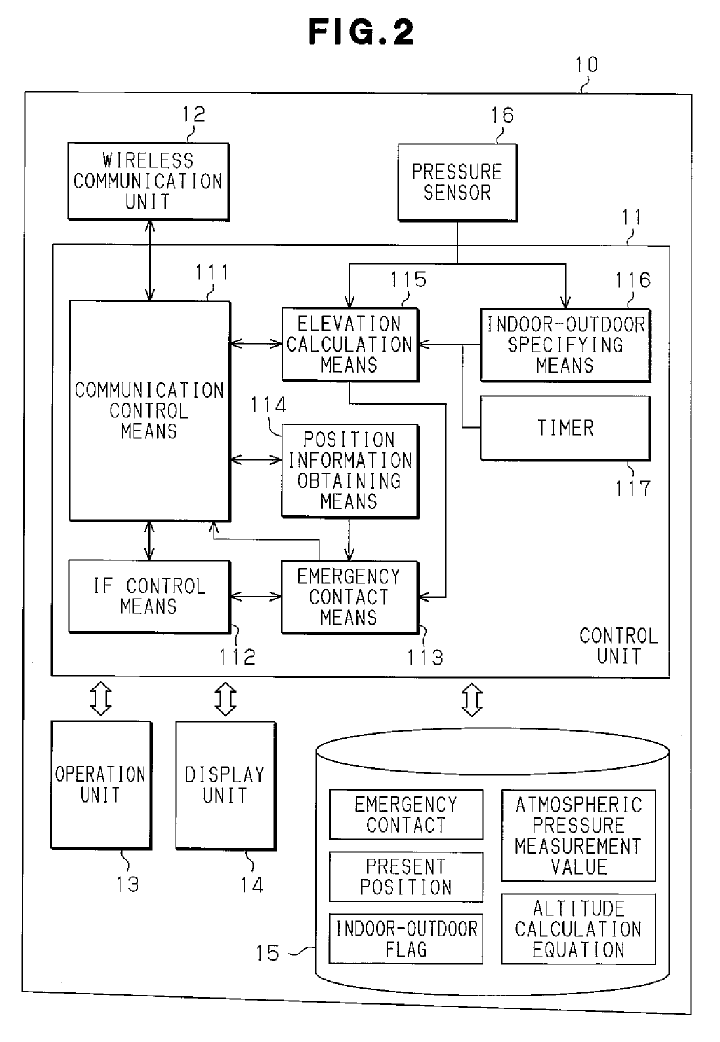

The internal structure of the cell phone 10 will now be described with reference to FIG. 2.

The cell phone 10 includes a control unit 11, a wireless communication unit 12, an operation unit 13, a display unit 14, a data memory 15 serving as an atmospheric pressure data memory, and a pressure sensor 16.

The control unit 11, which functions as a control means, includes a CPU, RAM, ROM, and the like (not shown) to perform processes that will be described later (processes including a detection step, a reference atmospheric pressure recording step, an elevation determination step, and an output step). The control unit 11 functions as a communication control means 111, an IF control means 112, an emergency contact means 113, a position information obtaining means 114, an elevation calculation means 115, an indoor-outdoor specifying means 116, and a timer 117.

The communication control means 111 controls the wireless communication unit 12 to enable it to exchange data with the base station 20.

The IF control means 112 controls interfaces for the operation unit 13 and the display unit 14. Specifically, the IF control means 112 controls the communication control means 111 and the emergency contact means 113 in response to instruction data obtained from the operation unit 13. Further, the IF control means 112 generates display screen data and displays a display screen on the display unit 14.

The emergency contact means 113, which functions as a reference atmospheric pressure recording means and an output means, performs a process for making an emergency call in response to an instruction from the IF control means 112.

The position information obtaining means 114 includes a GPS signal receiver, which determines the position of the cell phone 10 from a received GPS signal and records the position in the data memory 15 as two-dimensional position information.

The elevation calculation means 115, which functions as reference atmospheric pressure recording means and a elevation specifying means, performs an altitude calculation process to calculate the altitude of a present position. Specifically, the elevation calculation means 115 uses an altitude calculation equation as an altitude calculation function recorded in the data memory 15 to calculate the altitude of a present position. Then, the elevation calculation means 115 stores the altitude in the data memory 15. The elevation calculation means 115 periodically obtains reference atmospheric pressure information and updates the altitude calculation equation in the altitude calculation equation updating process, which will be described later. Further, the elevation calculation means 115 stores level movement detection patterns. The level movement detection patterns are patterns in which a gradual pressure increase or pressure decrease continues for a certain time or longer. The elevation calculation means 115 determines that the cell phone 10 has been moved by one level when variation of a atmospheric pressure measurement value for a predetermined period that is stored in the data memory 15 conforms to the level movement detection pattern. Whenever a level movement detection pattern for a pressure decrease is detected, the elevation calculation means 115 obtains moved level number data, described later, from the data memory 15, adds “1” to the moved level number data, and stores the updated moved level number data in the data memory 15. Further, whenever a level movement detection pattern for a pressure increase is detected, the elevation calculation means 115 obtains the moved level number data from the data memory 15, subtracts “1” from the moved level number data, and records the updated level movement detection data in the data memory 15. For example, referring to FIG. 7, when the user moves to the fifth floor via an escalator, the elevation calculation means 115 detects the level movement detection pattern for a pressure decrease when moving from the first floor to the second floor, when moving from the second floor to the third floor, when moving from the third floor to the fourth floor, and when moving from the fourth floor to the fifth floor. Thus, when the user ascends to the fifth floor via the escalator, a total of “5” (for 5 levels) is recorded as the moved level number data in the data memory 15.

The indoor-outdoor specifying means 116, which functions as detection means and correction means, detects whether a user is located indoor or outdoor and accordingly processes an indoor correction value. Normally, when the user enters a structure such as a building, the atmospheric pressure suddenly changes and increases. Thus, the indoor-outdoor specifying means 116 records, as an indoor detection condition, data related to an indoor-outdoor atmospheric pressure change threshold value to detect indoor-outdoor movement. The indoor-outdoor specifying means 116 detects that the user has moved into or out of a structure when a differential value of the atmospheric pressure obtained from the pressure sensor 16 is greater than or equal to the indoor-outdoor atmospheric pressure change threshold value. Further, when detecting that the user has moved into a structure and is located indoor, the indoor-outdoor specifying means 116 calculates the difference in the atmospheric pressure between indoor and outdoor states, and stores the difference in the data memory 15 as an indoor correction value contained in the altitude calculation equation. The indoor-outdoor specifying means 116 resets the stored indoor correction value to “0” when detecting that the user has moved out of a structure and is located outdoors.

The timer 117 provides time information to the elevation calculation means 115.

The operation unit 13 generates instructions that are sent to the control unit 11. In the first embodiment, the operation unit 13 has various operation buttons, which includes an emergency button. The IF control means 112 of the control unit 11 specifies the user's instruction data when the various operation buttons on the operation unit 13 are pushed.

The display unit 14 displays information so that the user can generate operation instructions and input data. In the first embodiment, the display unit 14 is a display. The IF control means 112 of the control unit 11 displays information on the display unit 14.

The data memory 15 stores various types of data. In the first embodiment, the data memory 15 stores data of emergency contacts, present position, indoor-outdoor flag, atmospheric pressure measurement value, and altitude calculation equation.

An emergency contact data area records data on emergency contacts (address information of the police and fire department).

The present position data area records data for specifying the present position of the cell phone 10. The present position includes two-dimensional position information (two-dimensional position), altitude position information (altitude of present position), and floor information (the number of moved levels). Thus, the present position data area includes areas allocated for each type of data. The two-dimensional position data area records data for specifying a two-dimensional position calculated from a GPS signal by the position information obtaining means 114. The present position altitude data area records data of the altitude calculated by the elevation calculation means 115. Further, the moved level number data area records data on the number of moved levels detected from the level movement detection patterns.

The indoor-outdoor flag data area records a flag specifying whether the present position of the cell phone 10 is situated indoors or outdoors. When indoor flag data is recorded in the indoor-outdoor flag data area, the user is located indoor. When outdoor flag data is recorded in the indoor-outdoor flag data area, the user is located outdoor.

The atmospheric pressure measurement value data area records an atmospheric pressure measurement value measured by the pressure sensor 16. In the present embodiment, the control unit 11 records the atmospheric pressure measurement value obtained by the pressure sensor 16 in the atmospheric pressure measurement value data area in association with time.

The altitude calculation equation data area stores data on an equation for calculating the altitude of the present position of the cell phone 10. In the first embodiment, the following equation is used as the altitude calculation equation:

altitude of present position={reference atmospheric pressure−(measured atmospheric pressure−indoor correction value)}×100/12+reference altitude

In the altitude calculation equation, the reference atmospheric pressure is the atmospheric pressure measured by the base station 20 (atmospheric pressure of reference atmospheric pressure information). The measured atmospheric pressure is the atmospheric pressure measured by the pressure sensor 16. The indoor correction value is the atmospheric pressure difference between an indoor location and an outdoor location.

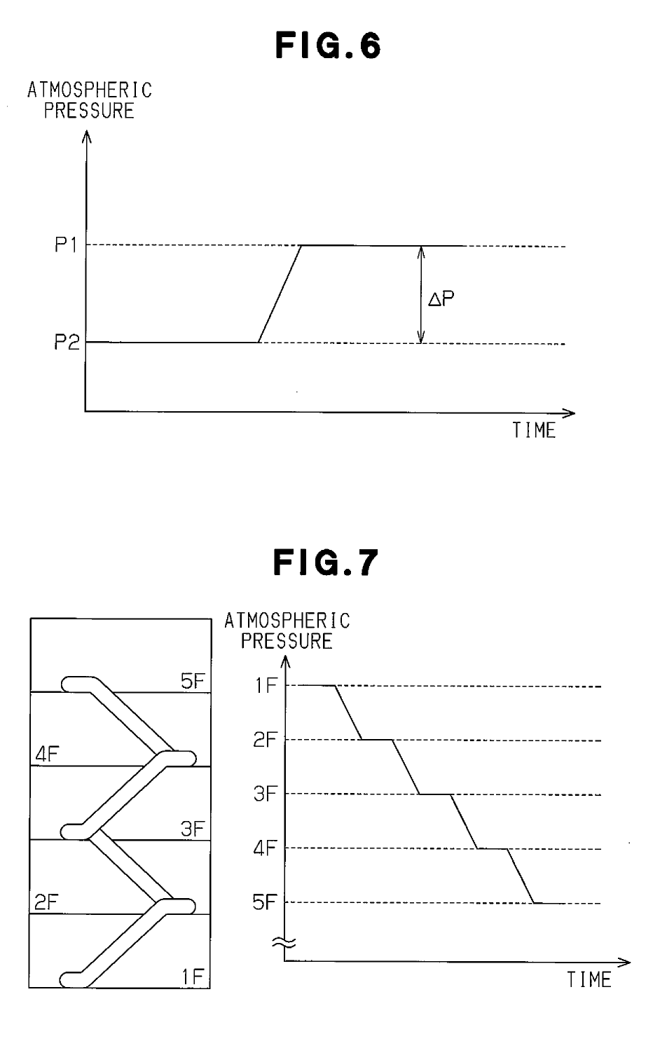

Referring to FIG. 6, since an indoor atmospheric pressure P1 is higher than an outdoor atmospheric pressure P2, the atmospheric pressure difference ΔP between indoor and outdoor locations is used as the indoor correction value. When the user is located outdoor, the altitude calculation equation uses the indoor correction value of “0”. The reference altitude is the altitude of the base station 20.

The pressure sensor 16 measures the atmospheric pressure at the cell phone 10 and provides the control unit 11 with data related to the measured atmospheric pressure.

A process for generating a notification of the user's present position with the cell phone 10 will now be discussed. An altitude calculation process, an indoor-outdoor process, an altitude calculation equation updating process, and an emergency contact process will be described in this order.

Altitude Calculation Process

The altitude calculation process will be first described.

The control unit 11 periodically performs a process for obtaining the measured atmospheric pressure. Specifically, the elevation calculation means 115 of the control unit 11 periodically obtains the atmospheric pressure measurement value of the pressure sensor 16 and records it in the atmospheric pressure measurement value data area of the data memory 15.

Next, the control unit 11 performs a process for calculating the elevation of a present position. Specifically, the elevation calculation means 115 of the control unit 11 substitutes the atmospheric pressure measurement value obtained from the pressure sensor 16 into the altitude calculation equation as the measured atmospheric pressure to calculate the altitude of the present position. Then, the elevation calculation means 115 records the calculated altitude in the data memory 15 as the altitude of the present position in the present position information.

Further, the elevation calculation means 115 determines whether a change in the atmospheric pressure measurement value stored in the atmospheric pressure measurement value data area of the data memory 15 conforms to a level movement detection pattern. In this case, when the change conforms to a level movement detection pattern, the elevation calculation means 115 obtains the moved level number data from the moved level number data area in the data memory 15, performs a computation in correspondence with the detected level movement detection pattern, obtains a new moved level number, and records the new moved level number to the moved level number data area of the data memory 15. When a level movement detection pattern is not detected or a moved level number is recorded, the altitude calculation process is terminated.

Indoor-Outdoor Specifying Process

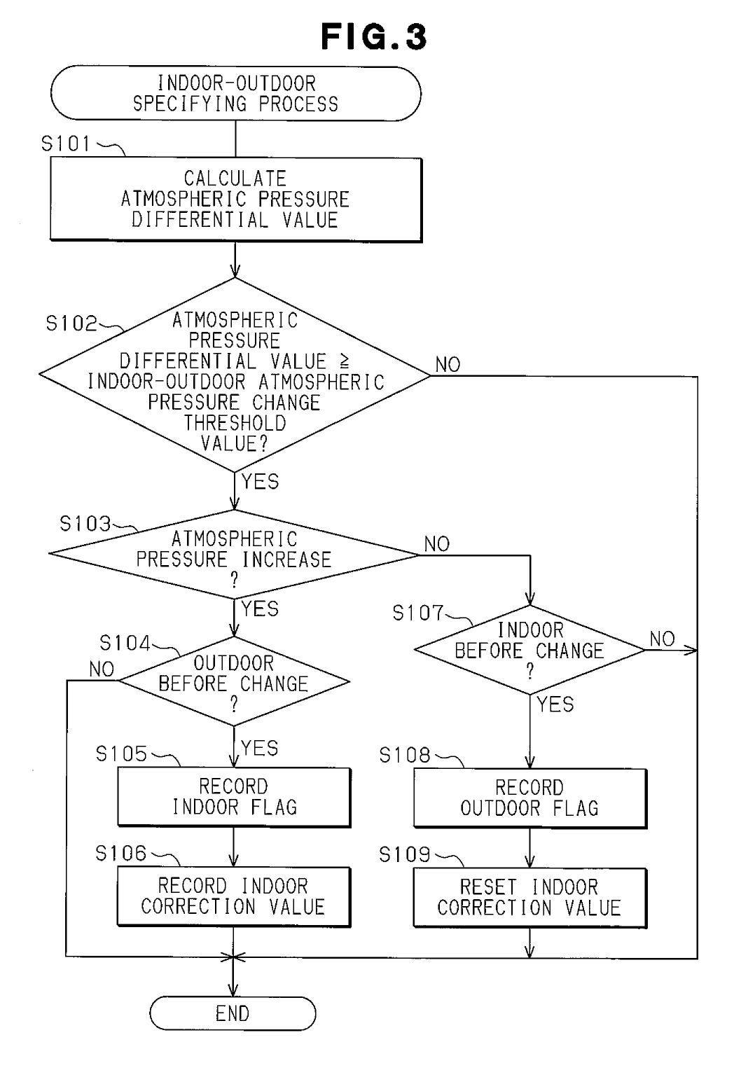

Next, the indoor-outdoor specifying process will be described with reference to FIG. 3.

In this process, when the control unit 11 obtains a new atmospheric pressure measurement value from the pressure sensor 16, an atmospheric pressure differential value calculation process is first performed (step S101). Specifically, the indoor-outdoor specifying means 116 of the control unit 11 calculates an atmospheric pressure differential value from the difference between the new atmospheric pressure measurement value (atmospheric pressure measurement value after change) and the immediately previous atmospheric pressure measurement value stored in the data memory 15 (atmospheric pressure measurement value before change).

Next, the control unit 11 determines whether the atmospheric pressure differential value for the latest predetermined time is greater than or equal to the indoor-outdoor atmospheric pressure change threshold value (step S102). Specifically, the indoor-outdoor specifying means 116 of the control unit 11 compares the atmospheric pressure differential value calculated in step S101 with the indoor-outdoor atmospheric pressure change threshold value stored in the indoor-outdoor specifying means 116. When the atmospheric pressure differential value is less than the indoor-outdoor atmospheric pressure change threshold value (“NO” in step S102), the indoor-outdoor specifying process is terminated.

If the atmospheric pressure differential value is greater than or equal to the indoor-outdoor atmospheric pressure change threshold value (“YES” in step S102), the control unit 11 determines whether the atmospheric pressure has increased (step S103). Specifically, the indoor-outdoor specifying means 116 of the control unit 11 compares the atmospheric pressure measurement value taken after the change and the atmospheric pressure measurement value taken before the change and determines whether the atmospheric pressure measurement value taken after change is greater.

When the atmospheric pressure has increased (“YES” in step S103), the control unit 11 determines whether the user was located outdoor before the change (step S104). Specifically, the indoor-outdoor specifying means 116 of the control unit 11 determines that the user was located outdoor before the change when the outdoor flag is recorded in the indoor-outdoor flag data area.

When determining that the user was located outdoors before change (“YES” in step S104), the control unit 11 performs an indoor flag recording process (step S105). Specifically, the indoor-outdoor specifying means 116 of the control unit 11 records the indoor flag in the indoor-outdoor flag data area of the data memory 15.

Next, the control unit 11 performs an indoor correction value recording process (step S106). Specifically, the indoor-outdoor specifying means 116 of the control unit 11 calculates an indoor correction value obtained by subtracting the atmospheric pressure measurement value taken before the change from the atmospheric pressure measurement value taken after the change. Then, the indoor-outdoor specifying means 116 records the indoor correction value in the data memory 15 as the indoor correction value of the altitude calculation equation. When the indoor correction value recording process (step S106) is terminated or when the user is located indoor before the change (“NO” in step S104), the control unit 11 terminates the indoor-outdoor specifying process.

If the atmospheric pressure decreases when the atmospheric pressure differential value is greater than or equal to the indoor-outdoor atmospheric pressure change threshold value (“NO” in step S103), the control unit 11 determines whether or not the user was located indoor before the change (step S107). Specifically, the indoor-outdoor specifying means 116 of the control unit 11 determines that the user was located indoor before the change when the indoor flag is recorded in the indoor-outdoor flag data area.

When the user was located indoor before the change (“YES” in step S107), the control unit 11 performs an outdoor flag recording process (step S108). Specifically, the indoor-outdoor specifying means 116 of the control unit 11 records the outdoor flag in the indoor-outdoor flag data area of the data memory 15.

Next, the control unit 11 performs an indoor correction value reset process (step S109). Specifically, the indoor-outdoor specifying means 116 of the control unit 11 records “0” as the indoor correction value of the altitude calculation equation recorded in the data memory 15. Further, in this case, the control unit 11 corrects the moved level number recorded in the moved level number data area of the data memory 15 to “0”.

Then, when the indoor correction value reset process (step S109) is terminated or the user is located outdoor before the change (“NO” in step S107), the control unit 11 terminates the indoor-outdoor specifying process.

Altitude Calculation Equation Updating Process

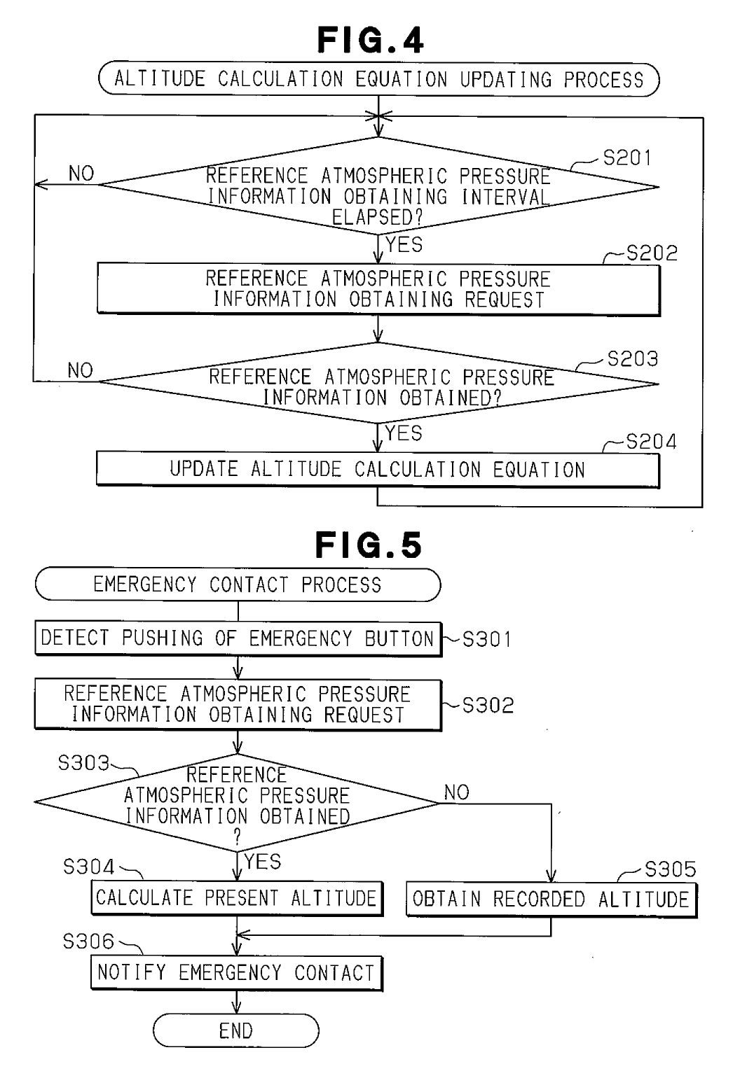

Next, the altitude calculation equation updating process will be described with reference to FIG. 4.

If the elapsed time from when the previous reference atmospheric pressure information was obtained exceeds a reference atmospheric pressure information obtaining interval (“YES” in step S201), the control unit 11 requests for reference atmospheric pressure information (step S202). Specifically, the elevation calculation means 115 of the control unit 11 uses the timer 117 to obtain information of the elapsed time after the previous reference atmospheric pressure information was obtained. When the reference atmospheric pressure information obtaining interval elapses, the elevation calculation means 115 provides an instruction for obtaining the reference atmospheric pressure information from the base station 20 to the communication control means 111. The communication control means 111 transmits a request for reference atmospheric pressure information via the wireless communication unit 12 to the base station 20, which covers the present position of the cell phone 10. The base station 20 that receives the request for reference atmospheric pressure information provides the reference atmospheric pressure information to the cell phone 10.

When the reference atmospheric pressure information cannot be obtained (“NO” in step S203), the control unit 11 waits until the next reference atmospheric pressure information obtaining interval elapses. In the first embodiment, when the control unit 11 does not receive data from the base station 20 even when waiting for the data for longer than the time required for normal communication due to the cell phone 10 being located outside the coverage area of the base station 20, the control unit 11 determines that the reference atmospheric pressure information is not received.

If the reference atmospheric pressure information is obtained (“YES” in step S203), the control unit 11 performs an altitude calculation equation updating process (step S204). Specifically, the elevation calculation means 115 of the control unit 11 obtains the reference atmospheric pressure information from the base station 20 via the wireless communication unit 12 and the communication control means 111. Further, the elevation calculation means 115 records the values of the reference atmospheric pressure and the reference altitude in the obtained reference atmospheric pressure information as the reference atmospheric pressure and the reference altitude for the altitude calculation equation in the data memory 15. Then, the control unit 11 waits until the next reference atmospheric pressure information obtaining interval elapses.

Emergency Contact Process

Next, an emergency contact process for making an emergency call will be described with reference to FIG. 5.

When an emergency button is pushed to make an emergency call, the control unit 11 in the cell phone 10 performs a process for detecting the pushing of the emergency button (step S301). Specifically, when the IF control means 112 of the control unit 11 obtains a signal indicating the pushing of the emergency button from the operation unit 13, the IF control means 112 provides the emergency contact means 113 with an instruction for performing the emergency contact process.

The control unit 11 performs a reference atmospheric pressure information obtaining request process (step S302). Specifically, when the emergency contact means 113 of the control unit 11 obtains an instruction for performing the emergency contact process, the emergency contact means 113 provides the communication control means 111 with an instruction for obtaining the reference atmospheric pressure information from the base station 20. The communication control means 111 transmits a request for reference atmospheric pressure information to the base station 20, with which data is being exchanged via the wireless communication unit 12. Upon receipt of the request, the base station 20 transmits the reference atmospheric pressure information stored in the reference data memory 21 to the cell phone 10.

When the reference atmospheric pressure information is obtained (“YES” in step S303), the control unit 11 performs a present altitude calculation process (step S304). Specifically, the emergency contact means 113 of the control unit 11 obtains the reference atmospheric pressure information from the base station 20 via the wireless communication unit 12 and the communication control means 111. Further, the emergency contact means 113 records the values of the reference atmospheric pressure and the reference altitude in the obtained reference atmospheric pressure information to the data memory 15 as the reference atmospheric pressure and the reference altitude for the altitude calculation equation. Then, the emergency contact means 113 provides the elevation calculation means 115 with an instruction for performing the altitude calculation process described above. Specifically, the elevation calculation means 115 obtains the atmospheric pressure measurement value obtained by the pressure sensor 16, uses the atmospheric pressure measurement value to calculate the altitude of the present position, and records the altitude of the present position in the data memory 15. Then, the emergency contact means 113 obtains the present position data recorded in the data memory 15. In this case, the present position data includes the two-dimensional position and altitude of the present position. When the moved level number is not “0” in the data memory 15, the present position data includes data related to the moved level number.

If the reference atmospheric pressure information cannot be obtained (“NO” in step S303), the control unit 11 performs a process for obtaining the altitude recorded in the data memory 15 (step S305). Specifically, when the emergency contact means 113 of the control unit 11 does not receive data from the base station 20 even after waiting for longer than the time required for normal communication, the emergency contact means 113 obtains the present position data recorded in the data memory 15.

Then, the control unit 11 performs a process for issuing a notification to an emergency contact (step S306). Specifically, the emergency contact means 113 of the control unit 11 obtains the emergency contact data from the data memory 15. Further, the emergency contact means 113 obtains the present position information stored in the data memory 15 to generate an emergency notification including the information. Then, the emergency notification is transmitted via the base station 20 to the emergency contact. The present position information includes the present altitude calculated in step S304 or the present altitude including the data related to the altitude obtained in step S305, the two-dimensional position information specified through the GPS signal, and the information on the moved level number when information on the moved level number is recorded to the data memory 15. This completes the emergency contact process.

The first embodiment has the advantages described below.

In the first embodiment, if the elapsed time from when the previous reference atmospheric pressure information was obtained exceeds the reference atmospheric pressure information obtaining interval, the control unit 11 requests for reference atmospheric pressure information (step S202). The control unit 11 obtains the reference atmospheric pressure information from the base station 20 with which data is being exchanged (“YES” in step S203) and performs the altitude calculation equation updating process for storing the reference atmospheric pressure information in the data memory 15 (step S204). Further, the control unit 11 periodically performs the process for obtaining the measured atmospheric pressure and a process for calculating the elevation of the present position. In this case, the control unit 11 substitutes the atmospheric pressure measurement value obtained from the pressure sensor 16 as the measured atmospheric pressure into the altitude calculation equation to calculate the altitude of the present position. Then, the control unit 11 records the calculated altitude to the data memory 15. When the emergency button is pushed, the control unit 11 performs a process for issuing a notification to an emergency contact (step S306). In this case, the control unit 11 obtains the present position data recorded in the data memory 15 and transmits the two-dimensional position and altitude of the present position (and in some cases the moved level number) contained in the present position data via the base station 20 to the emergency contact. The atmospheric pressure varies is accordance with the altitude. The atmospheric pressure also varies in accordance with the local weather. In the first embodiment, the control unit 11 in the cell phone 10 updates the altitude calculation equation with the reference atmospheric pressure information periodically obtained from the base station 20 with which data is exchanged. Thus, in the range covered by the base station 20, the altitude of the present position is calculated while periodically updating the altitude calculation equation using more accurate reference atmospheric pressure information. This allows the user's present position to be specified with further accuracy even in a multi-level area. As a result, even if the user's present position cannot be directly specified from map information, the emergency contact that receives an emergency notification can specify the user's present position (calling position) with further accuracy.

In the first embodiment, the control unit 11 obtains the reference atmospheric pressure information including the atmospheric pressure measured at the base station 20, with which data is exchanged, and the altitude of the base station 20 to perform the altitude calculation equation updating process (step S204). The range in which the base station 20 exchanges the data with the cell phone 10 is narrower as compared with the distance in which the weather changes the atmospheric pressure. Thus, correction may be carried out by using the altitude and the atmospheric pressure of the base station 20, at which the atmospheric pressure dependent on the weather is substantially the same as the user's present position, as the reference atmospheric pressure information. As a result, the user's present altitude is calculated with further accuracy.

In the first embodiment, when obtaining a new atmospheric pressure measurement value from the pressure sensor 16, the control unit 11 performs the atmospheric pressure differential value calculation process (step S101). Further, if the atmospheric pressure differential value is greater than or equal to the indoor-outdoor atmospheric pressure change threshold value (“YES” in step S102), the control unit 11 determines whether or not the atmospheric pressure has increased (step S103). When the atmospheric pressure has increased and the user was located outdoor before the change (“YES” in step S104), the control unit 11 performs the indoor flag recording process (step S105) and the indoor correction value recording process (step S016). If the atmospheric pressure has decreased and the user was located indoor before the change (“YES” in step S107), the control unit 11 performs the outdoor flag recording process (step S108) and the indoor correction value reset process (step S109). When the user enters a structure such as a building and the atmospheric pressure suddenly increases, the control unit 11 records the indoor correction value. Thus, if the atmospheric pressure increases because the user enters a building, this fact is used to calculate the user's present altitude. This enables the altitude of the user's present position to be calculated with further accuracy.

In the first embodiment, in the process for issuing a notification to an emergency contact (step S306), the control unit 11 sends to the emergency contact an emergency notification including the present position information stored in the data memory 15. The present position information includes the two-dimensional position information specified with the GPS signal. Thus, the emergency contact is provided with the two-dimensional position information and the user's present altitude. This allows the emergency contact to specify the calling position with further efficiency.

In the first embodiment, in the present position elevation calculation process of the altitude calculation process, the control unit 11 calculates the altitude of the present position and records the altitude in the data memory 15. When the altitude conforms to a level movement detection pattern, the control unit specifies the number of moved levels in correspondence with the level movement detection pattern and records the moved number level to the present position data area of the data memory 15. In the process for issuing a notification to an emergency contact (step S306), the control unit 11 obtains the data related to the present position stored in the data memory 15 and sends an emergency notification, which includes this data, to the emergency contact. When information relating to the moved level number is recorded in the data memory 15, the data related to the present position includes the moved level number data. Since the height of a single level, or floor, differs between buildings, the moved level number data may be used to specify the user's present position (present level) with further accuracy.

In the first embodiment, in the emergency contact process, when detecting the pushing of the emergency button, the control unit 11 performs the reference atmospheric pressure information obtaining request process (step S302). When the reference atmospheric pressure information is obtained (“YES” in step S303), the control unit 11 performs the present altitude calculation process. The reference atmospheric pressure information is requested when the user's present position is notified. Thus, the reference atmospheric pressure information corresponding to the present position that is to be notified is newly obtained and corrections are made using the reference atmospheric pressure information. This allows the user's present position to be specified with further accuracy.

### Second Embodiment

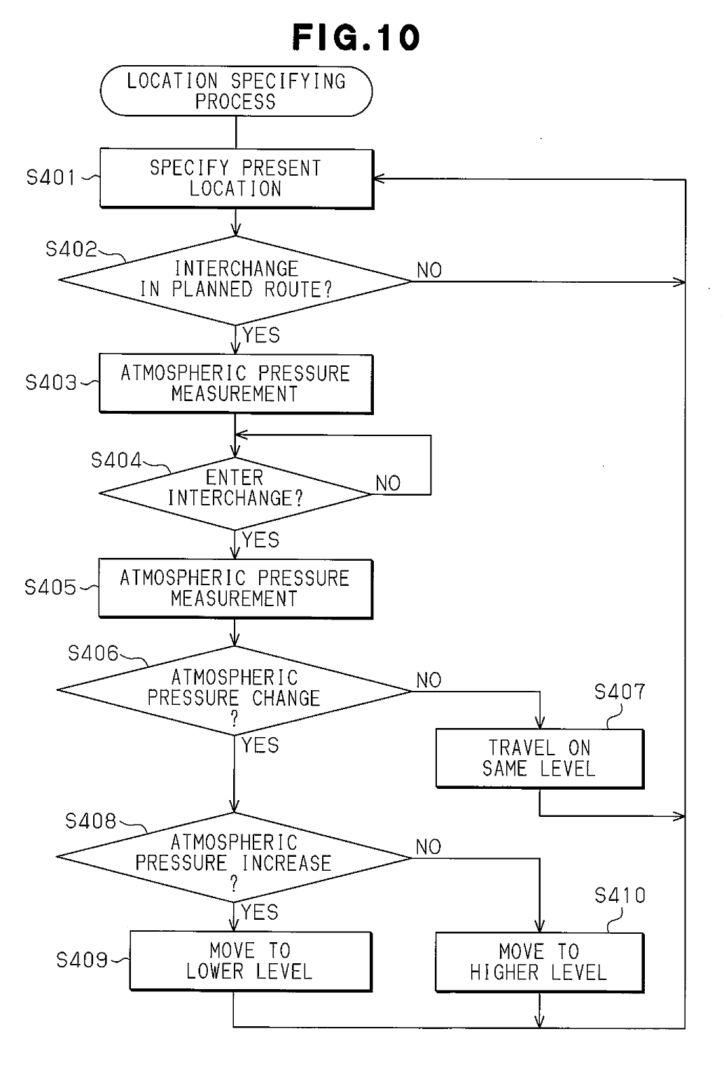

A second embodiment of the present invention will be now discussed with reference to FIGS. 9 and 10. The second embodiment is a navigation apparatus serving as a present position output apparatus that outputs the present position of an automobile, or car, in which a user is riding

As shown in FIG. 9, a navigation apparatus 40 installed in a car includes a control unit 41, a GPS receiver 42, an operation unit 43, a display unit 44, a map data memory 45, and a pressure sensor 46.

The control unit 41, which functions as a control means, includes a CPU, RAM, ROM, and the like (not shown) to perform processes that will be described later (processes including a detection step, a reference atmospheric pressure recording step, an elevation determination step, and an output step). The control unit 41 functions as a navigation display control means 410, an IF control means 411 and, an elevation detection means 412.

The navigation display control means 410 functions as a map information obtaining means, a detection means, a reference atmospheric pressure recording means, and an output means. Further, the navigation display control means 410 controls a display process for guiding (navigating) a user to a destination. Specifically, the navigation display control means 410 calculates user position information specified by the GPS receiver 42. Further, the navigation display control means 410 obtains map information corresponding to the user's present position from the map data memory 45. Then, the navigation display control means 410 generates and displays a navigation screen on the display unit 44 indicating directions to the destination. When the user's car is traveling along an interchange, which is a multi-level area, the navigation display control means 410 obtains information for specifying the level on which the user's car is traveling from the elevation detection means 412 and accordingly specifies the present position.

The user uses the operation unit 43, which includes various operation buttons, to generate a user instruction. The IF control means 411 obtains the user instruction from the operation unit 43 and displays the instruction on the display unit 44.

The elevation detection means 412 functions as an elevation specifying means, obtains data related to the atmospheric pressure measured by the pressure sensor 46 to specify the level of the interchange on which the user's car is traveling. Then, the elevation detection means 412 provides traveling level specifying information to the navigation display control means 410. Further, the elevation detection means 412 stores a tolerable pressure change value of the tolerated change in atmospheric pressure when the user's car is traveling on the same level of the interchange.

The GPS receiver 42 specifies the position of the car using the navigation apparatus 40 from a received GPS signal.

The map data memory 45 records data related to the map information.

The pressure sensor 46 measures the atmospheric pressure of the car using the navigation apparatus 40. Then, the pressure sensor 46 provides the control unit 41 with data related to the measured atmospheric pressure.

Next, a location specifying process using the above navigation apparatus 40 will be described with reference to FIG. 10. As known in the art, when using the navigation apparatus 40, the user inputs information for specifying a destination into the control unit 41 with the operation unit 43.

First, the control unit 41 performs a present location specifying process (step S401). Specifically, the navigation display control means 410 of the control unit 41 obtains GPS information for specifying the car's position from the GPS receiver 42. Then, the navigation display control means 410 uses the GPS information to obtain map information for the position where the car is traveling from the map data memory 45. The navigation display control means 410 generates and displays a navigation screen including the present position and traveling directions to the destination on the display unit 44 via the IF control means 411.

The control unit 41 determines whether an interchange is included in the planned route or directions (step S402). Specifically, when detecting from the map information, which is obtained from the map data memory 45, that an interchange is included within the range of the route or directions displayed on the display unit 44, the navigation display control means 410 of the control unit 41 determines whether the interchange is located in the planned route.

When an interchange is included in the planned route (“YES” in step S402), the control unit 41 performs an atmospheric pressure measurement process (step S403). Specifically, the elevation detection means 412 of the control unit 41 obtains the atmospheric pressure measurement value measured by the pressure sensor 46 and records the atmospheric pressure measurement value in the RAM of the control unit 41. In the second embodiment, the present atmospheric pressure measurement value is used as the reference atmospheric pressure of the reference atmospheric pressure information. Further, the present altitude is used as the reference elevation “0”.

Subsequently, when the car enters the interchange (“YES” in step S404), the control unit 41 performs the atmospheric pressure measurement process again (step S405). Specifically, the elevation detection means 412 of the control unit 41 obtains the atmospheric pressure measurement value measured by the pressure sensor 46 and stores the atmospheric pressure measurement value in the RAM of the control unit 41.

Then, the control unit 41 determines whether or not the atmospheric pressure has changed (step S406). Specifically, the elevation detection means 412 of the control unit 41 compares the atmospheric pressure measurement value recorded to the RAM in step S403 with the atmospheric pressure measurement value recorded to the RAM in step S405. When the difference between the two atmospheric pressure measurement values is greater than or equal to the tolerable pressure change value, the elevation detection means 412 determines that the atmospheric pressure has changed.

When there is no pressure change that is greater than and equal to the tolerable pressure change value and the atmospheric pressure is determined as not changed (“NO” in step S406), the control unit 41 determines that the car is traveling on the same level of a road (step S407). Specifically, the elevation detection means 412 of the control unit 41 provides the navigation display control means 410 with level specifying information indicating that the car is traveling on the same level as before entering the interchange.

If it is determined that the atmospheric pressure has changed (“YES” in step S406), the control unit 41 determines whether or not the atmospheric pressure has increased (step S408).

When an increase in the atmospheric pressure is detected (“YES” in step S408), the control unit 41 determines that the car has moved to a lower level (step S409). Specifically, when the pressure measured in step S405 is higher than the pressure measured in step S403, the elevation detection means 412 of the control unit 41 determines that the car has moved to a lower level. In this case, the elevation detection means 412 of the control unit 41 provides the navigation display control means 410 with level specifying information indicating that the car is traveling on a level that is lower than the level on which the car was traveling before entering the interchange.

When a decrease in the atmospheric pressure is detected (“NO” in step S408), the control unit 41 determines that the car has moved to a higher level (step S410). Specifically, when the pressure measured in step S405 is lower than the pressure measured in step S403, the elevation detection means 412 of the control unit 41 determines that the car has moved to a higher level. In this case, the elevation detection means 412 of the control unit 41 provides the navigation display control means 410 with level specifying information indicating that the car is traveling on a level than is higher than the level on which the car was traveling before entering the interchange.

The control unit 41 uses the obtained level specifying information to perform the present location specifying process (step S401). Specifically, the navigation display control means 410 obtains the information specifying the car's position and the map information corresponding to the car's position. Then, the navigation display control means 410 uses the information together with the level specifying information obtained from the elevation detection means 412 to generate a navigation screen including the present position and directions to the destination. The navigation display control means 410 displays via the IF control means 411 the navigation screen with map information on the display unit 44. When an interchange is included in the planned route (“YES” in step S402), the processes following step S403 are repeatedly performed.

The second embodiment has the advantages described below.

In the second embodiment, when an interchange is included within the range of the route, or directions, displayed on the display unit (“YES” in step S402), the control unit 41 obtains the atmospheric pressure measurement value measured by the pressure sensor 46 and records the atmospheric pressure measurement value to the RAM of the control unit 41 (step S403). Subsequently, when the car enters the interchange (“YES” in step S404), the control unit 41 obtains the atmospheric pressure measurement value measured by the pressure sensor 46 and stores the atmospheric pressure measurement value in the RAM of the control unit 41 again (step S405). When it is determined that there is no change in the atmospheric pressure (“NO” in step S406), the control unit 41 determines that the car is traveling on the same level of a road (step S407). When the atmospheric pressure increases (“YES” in step S408), the control unit 41 determines that the car has moved to a lower level (step S409). When the atmospheric pressure decreases (“NO” in step S408), the control unit 41 determines that the car has moved to a higher level (step S410). The control unit 41 uses the level specifying information indicating that the car is traveling along the determined level (the level which is the same as, lower than, or higher than the level on which the car was traveling before entering the interchange) to perform the present location specifying process (step S401). Thus, the atmospheric pressure measurement values measured before and after entering the interchange are compared to specify the level on which the car is traveling. The level is difficult to specify when using two-dimensional position information. In this case, the distance from the interchange, the position of which is detected from the map information, to the user's present position is shorter than the distance in which the weather changes the atmospheric pressure. Therefore, the atmospheric pressure that is dependent on the weather is substantially the same before and after entering the interchange. As a result, the present position of the car in the interchange is specified with further accuracy without being affected by changes in the atmospheric pressure caused by weather. This allows for further accurate navigation to be performed in correspondence with the present position.

It should be apparent to those skilled in the art that the present invention may be embodied in many other specific forms without departing from the spirit or scope of the invention. Particularly, it should be understood that the present invention may be embodied in the following forms.

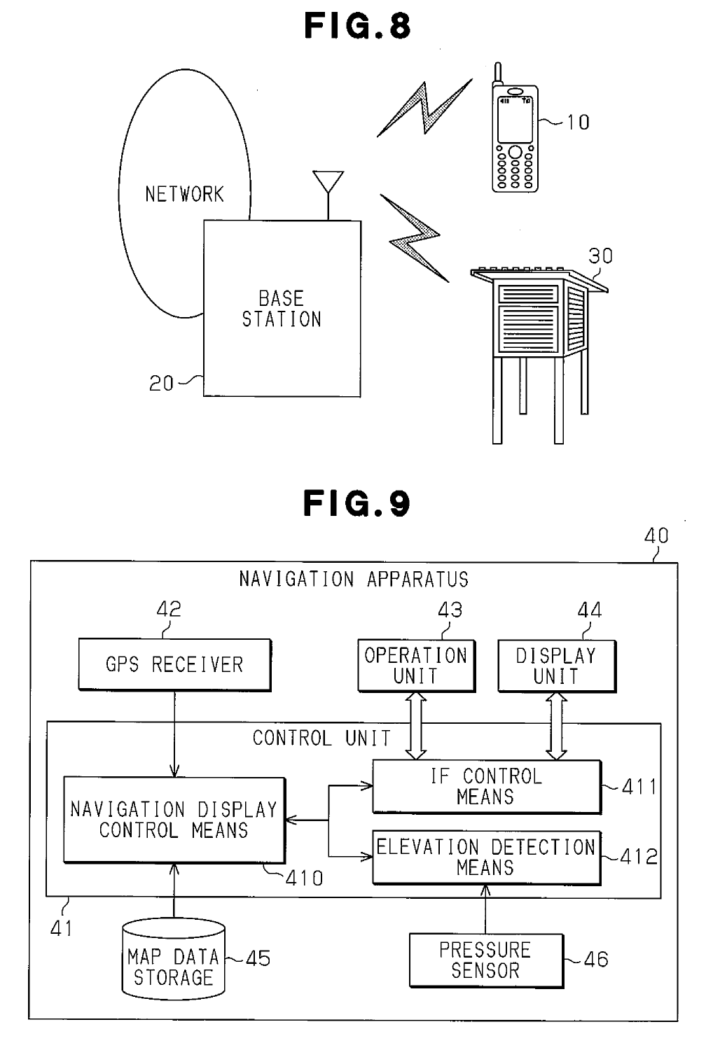

In the first embodiment, the control unit 11 in the cell phone 10 uses the reference atmospheric pressure information including the altitude of the base station 20, with which data is exchanged, and the atmospheric pressure measured at the base station 20 to update the altitude calculation equation. However, the reference atmospheric pressure information used by the cell phone 10 to update the altitude calculation equation is not limited in such a manner. For example, the base station 20 may provide the atmospheric pressure and altitude of a reference atmospheric pressure information provider located near the cell phone 10. Specifically, as shown in FIG. 8, the reference atmospheric pressure information may be obtained from reference atmospheric pressure information providers, which are located in the area covered by the base station 20, such as an instrument shelter 30 or Automated Meteorological Data Acquisition System (AMeDAS), which is a regional observation system of the Meteorological Office. In this case, the reference atmospheric pressure information provider includes a pressure sensor for measuring the atmospheric pressure, a memory for storing reference atmospheric pressure information including the altitude and atmospheric pressure measurement value, a data update control means, and a communication control means. The data update control means in the reference atmospheric pressure information provider periodically updates the atmospheric pressure measured by the pressure sensor as the atmospheric pressure measurement value of the reference atmospheric pressure information recorded to the memory. The base station 20 includes a data storage. The data storage stores provider identifiers for identifying the reference atmospheric pressure information providers and data associating the provider identifiers with position information.

When generating a reference atmospheric pressure information obtaining request, the cell phone 10 includes in the reference atmospheric pressure information obtaining request the two-dimensional position stored in the present position data of the data memory 15. The base station 20 compares the two-dimensional position included in the received reference atmospheric pressure information obtaining request with the position information of the reference atmospheric pressure information providers to specify the reference atmospheric pressure information provider located closest to the cell phone 10. The base station 20 sends a reference atmospheric pressure information transmission request to the specified reference atmospheric pressure information provider. The communication control means in the reference atmospheric pressure information provider transmits the reference atmospheric pressure information recorded in the memory to the base station 20. The base station 20 then transmits the obtained reference atmospheric pressure information to the cell phone 10. In this case, the reference atmospheric pressure and the reference altitude are obtained from the location closest to the cell phone 10. Furthermore, the base station 20 does not need to include the pressure sensor and does not have to store the reference atmospheric pressure information.

The base station 20 may be connected to each reference atmospheric pressure information provider via a reference information management server. In this case, for example, the reference information management server stores the provider identifiers and the associated position information. When obtaining the reference atmospheric pressure information transmission request including the two-dimensional position of the cell phone 10 from the base station 20, the reference information management server compares the two-dimensional position included in the reference atmospheric pressure information obtaining request with the position information of the reference atmospheric pressure information providers to specify the reference atmospheric pressure information provider having the reference atmospheric pressure information for the location closest to the two-dimensional position of the cell phone 10. The reference information management server obtains and transmits the reference atmospheric pressure information from the specified reference atmospheric pressure information provider to the cell phone 10 via the base station 20. Further, the reference information management server may hold reference atmospheric pressure information used for different regions. Specifically, the reference information management server periodically obtains atmospheric pressure from each reference atmospheric pressure information provider. Then, the reference information management server calculates a reference atmospheric pressure and a reference altitude applied to predetermined periods for each region in accordance with the movement of low pressure or high pressure systems. The reference information management server stores reference atmospheric pressure information including the reference atmospheric pressure and reference altitude in association with position information for specifying each region. The reference information management server compares the two-dimensional position included in the reference atmospheric pressure information obtaining request with the regional position information to specify the region including the two-dimensional position of the cell phone 10. Then, the reference information management server obtains and transmits the reference atmospheric pressure information of the region to the cell phone 10 via the base station 20.

In the first embodiment, when performing a process for issuing a notification to an emergency contact (step S306), the control unit 11 sends an emergency notification including the present position information to the emergency contact. Further, in the second embodiment, the control unit 41 uses the level specifying information indicating that the car is traveling on the specified level to perform the present location specifying process (step S401). However, the present position information that is output is not limited to such information and other information may be output. For example, in the first embodiment, the control unit 11 may store the “average height of a single floor.” The control unit 11 divides the present position altitude, which is calculated with the altitude calculation equation, by the stored “average height of a single floor” when generating an emergency notification including the present position information and the information of the floor (level) on which the user is located.

In the first embodiment, in the altitude calculation equation updating process or emergency contact process, the control unit 11 sends a reference atmospheric pressure information obtaining request to the base station 20 to obtain the reference atmospheric pressure information from the base station 20. Instead, the base station 20 may periodically transmit the reference atmospheric pressure information to the control unit 11.

In the first embodiment, data related to the indoor-outdoor atmospheric pressure change threshold value for detecting the indoor-outdoor movement is used as the indoor detection condition. However, the indoor detection condition for detecting movement of the user into or out of a structure is not limited in such a manner. For example, if the atmospheric pressure varies so as to conform with a predetermined pattern when the user moves into a structure, the pattern may be stored in the indoor-outdoor specifying means 116 of the control unit 11 as the indoor detection condition.

In the second embodiment, when an interchange is included in the map information, the control unit 11 performs the location specifying process. The location specifying process may be performed not only for an interchange but also for a multi-level area when the user's present position cannot be directly specified from the plan map information. Further, in the second embodiment, the navigation apparatus 40 is used in a car but may be held by a person instead.

The present examples and embodiments are to be considered as illustrative and not restrictive, and the invention is not to be limited to the details given herein, but may be modified within the scope and equivalence of the appended claims.

1. A present position output apparatus, comprising:
a pressure sensor that measures atmospheric pressure;
an atmospheric pressure data memory, connected to the pressure sensor, for storing the atmospheric pressure measured by the pressure sensor; and
a controller, connected to the atmospheric pressure data memory, the controller including:
a detection means for detecting movement into a multi-level area;
a reference atmospheric pressure memory for obtaining a reference elevation and a reference atmospheric pressure that correspond with the multi-level area and storing the reference elevation and reference atmospheric pressure to the atmospheric pressure data memory;
an elevation specifying means for comparing the atmospheric pressure measured by the pressure sensor with the reference atmospheric pressure and specifying the elevation of a present position at which the atmospheric pressure was measured based on the comparison result; and
an output means for outputting information related to the specified elevation of the present position.

2. The present position output apparatus of claim 1, further comprising:
a wireless communication unit, coupled to the controller, that communicates with a base station;
wherein the reference atmospheric pressure memory periodically obtains information related to the reference elevation and the reference atmospheric pressure from a base station with which the wireless communication unit is communicating; and
wherein the elevation specifying means calculates the elevation of the present position from the reference elevation and a pressure difference between the atmospheric pressure measured by the pressure sensor and the reference atmospheric pressure.

3. The present position output apparatus of claim 1, wherein:
the controller stores an indoor detection condition to detect movement into an indoor location from an outdoor location;
the detection means detects movement into the multi-level area by detecting that the atmospheric pressure stored in the atmospheric pressure data memory satisfies the indoor detection condition; and
the controller further includes a correction means for correcting the reference atmospheric pressure when movement into the multi-level area is detected using a difference between the atmospheric pressure before the detection and the atmospheric pressure after the detection.

4. The present position output apparatus of claim 1, wherein:
the controller further includes a map information obtaining means for obtaining map information on a user's traveling direction within a predetermined range that is simultaneously displayed;
the detection means detects a multi-level area from the map information;
the reference atmospheric pressure memory sets the atmospheric pressure measured when detecting the multi-level area as the reference atmospheric pressure and the elevation when detecting the multi-level area as the reference elevation;
when the atmospheric pressure measured after entering the multi-level area is the same as the reference atmospheric pressure, the elevation specifying means specifies the elevation measured before entering the multi-level area as the elevation of the present position;
when the atmospheric pressure measured after entering the multi-level area differs from the reference atmospheric pressure, in accordance with the difference between the atmospheric pressures, the elevation specifying means specifies an elevation of a position that is lower than or higher than the elevation measured before entering the multi-level area as the elevation of the present position;
the output means outputs navigation information including a user's present position, which corresponds to the specified elevation of the present position, and map information, which is obtained by the map information obtaining means.

5. A method for outputting present position with a present position output apparatus including a pressure sensor that measures atmospheric pressure, an atmospheric pressure data memory for storing the atmospheric pressure measured by the pressure sensor, and a control means, the method comprising:
the control means performing:
a detection step for detecting movement into a multi-level area;
a reference atmospheric pressure recording step for obtaining a reference elevation and a reference atmospheric pressure that correspond with the multi-level area and storing the reference elevation and reference atmospheric pressure to the atmospheric pressure data memory;
an elevation determining step that compares the atmospheric pressure measured by the pressure sensor with the reference atmospheric pressure and calculates the elevation of a present position at which the atmospheric pressure was measured based on the comparison result; and
an output step for outputting information related to the specified elevation of the present position.

6. (canceled)
